(19) United States
(12) Patent Application Publication
(10) Pub. No.: US 2009/0082505 A1
(43) Pub. Date: Mar. 26, 2009

(54) Water Based Pipeline Primer

(76) Inventors: Martin Sorensen, Vejle (DK); Keith Jackson, Denbighshire (GB)

Correspondence Address: Richard F. Jaworski;c/o Cooper & Dunham LLP, 1185 Avenue of The Americas, New York, NY, 10036, US

(21) Appl. No.: 12/087,718

(22) PCT Filed: Jan. 15, 2007
(86) PCT No.: PCT/DK2007/000021

§ 371 Date: Jul. 10, 2008

(30) Foreign Application Priority Data
Jan. 16, 2006 (DK) PA 2006 00066

(51) Int. Cl. C08K 3/32; C08L 67/06; C08K 3/34

(52) U.S. Cl. 524/417; 524/599; 524/449; 524/451; 524/560

(57) ABSTRACT

A water based primer and a method for protecting iron or steel materials against corrosion by first priming with a water borne primer composition containing a) a binder of one or more acrylic copolymers based on one or more acrylic monomers and one or more chlorinated monomers, b) a corrosion inhibiting pigment, c) one or more further pigments, d) optionally conventional additives and/or adjuvants, and e) water and then coating with a bituminous material. Contrary to the current primers on organic solvent basis the water borne primer gives low to no emission of volatile organic compounds (VOCs) and still fulfils the requirements for anti-corrosive effect, cohesive and adhesive strength.

### TECHNICAL FIELD

The present invention relates to a method for protecting iron or steel materials. Furthermore the invention relates to a primer to be used in the method and the use of the primer prior to a coating with a bituminous material.

### TECHNICAL BACKGROUND

Conventional protection of materials against corrosion, of for instance pipes to be used both offshore and onshore, starts with priming with a primer followed by hot application of a bituminous material. To support the bituminous material one or more layers of wrapping material or another supporting system such as a polymer coat is/are simultaneously applied to the liquid bituminous material.

The purpose of the primer is to ensure adhesion both with the metallic surface of the pipe and with the bituminous coating. It is also important that the entire protection system is sufficiently impermeable so as to ensure a high resistance against cathodic disbanding.

Some conventional primers consists of chlorinated rubber or a hydrocarbon resin, a plasticizer and a colouring matter together with solvents needed to give a consistency suitable for applying the primer.

WO 92/06141 discloses a primer including polychloroprene, chlorinated caoutchouc, terpene phenolic, silane and carbon black with xylene and methylenechloride as the solvents. This primer has been used in practice with an effective adhesion to the metal surface and to a bitumen based enamel. However the use of organic solvents leads to emissions of volatile organic compounds (VOCs). Such emissions are environmentally damaging and according to Directive 2004/42/CE of the European Parliament and of the Council of 21 Apr. 2004 primers based on such volatile organic solvents will be phased out in the near future.

The European Standard EN 10300:2005 from European Committee for Standardization (CEN): “Steel tubes and fittings for onshore and offshore pipelines—Bituminous hot applied materials for external coating” mentions further to the above mentioned types of primers based on chlorinated rubber or hydrocarbon resin aqueous primers which are based on epoxy resins. Examples of this type of primers are the waterborne epoxy resin coating compositions disclosed in WO 00/01780 and WO 00/04106. Although such waterborne primers could avoid the emission of VOCs, the use of epoxy resins involves health hazards for the operator applying such primers.

Thus although the EN 10300:2005 allows epoxy resins in the primers there is a need for a less hazardous primer still being on an aqueous basis.

It is known to add a corrosion inhibiting pigment such as aluminium triphosphate to coating materials on acrylic basis to obtain coatings with anti-corrosive properties. To ensure the anti-corrosive properties the amount of the corrosion inhibiting pigment in such conventional coating materials is typically from 17 to 25 parts by weight based on 100 parts by weight of the acrylic binder both calculated as dry matter. Although such coatings used alone or as primers for many applications are found to have a satisfactory anti-corrosive effect, they have insufficient cohesive, adhesive and/or anti-corrosive effects when used as a primer applied on for instance onshore or offshore pipelines and followed by hot application of a bituminous material.

Accordingly it is an object of the present invention to provide a method and a primer formulation for the protection of materials against corrosion in combination with a coating of a bituminous material which method and primer fulfil the requirements for an anti-corrosive effect, cohesive and adhesive strength, low to no emission of VOCs.

### BRIEF DESCRIPTION OF THE INVENTION

Accordingly the present invention relates to a method of protecting iron or steel materials against corrosion, characterised by priming with a water borne primer composition containing a) a binder of one or more acrylic copolymers based on one or more acrylic monomers and one or more chlorinated monomers, b) a corrosion inhibiting pigment, c) one or more further pigments, d) optionally conventional additives and/or adjuvants, and e) water, and coating with a bituminous material.

The invention also relates to a bonding and anti-corrosive primer, characterised in, that it is an aqueous composition containing a) a binder of one or more acrylic copolymers based on one or more acrylic monomers and one or more chlorinated monomers, b) a corrosion inhibiting pigment, c) one or more further pigments, d) optionally conventional additives and/or adjuvants, and e) water.

In a preferred embodiment the content of the corrosion inhibiting pigment (b) is 2 to 12 parts by weight, more preferred, 3 to 8 parts by weight, based on 100 parts by weight of the binder (a) both calculated as dry matter.

In a further preferred embodiment a substantial portion of the further pigments (c), i.e. the remaining pigments apart from the corrosion inhibiting pigment, includes lamellar pigments. Use of lamellar pigments gives a primer with improved adhesive and cohesive strengths and also assists in reducing the rate of water diffusion through the coating.

In principle any known corrosion inhibiting pigments are usable as the component b). Suitable examples of the corrosion inhibiting pigments are metal phosphate pigments. Any such metal phosphate pigments are usable as the corrosion inhibiting pigments (b) provided the metal cation has no detrimental effect on the primer performance. Not limiting examples of contemplated corrosion inhibiting pigments are aluminium triphosphate, barium phosphate, zinc phosphate, phosphosilicates and ion exchanged pigments including mixtures thereof.

Examples of suitable lamellar pigments (c) are talc (magnesium silicate hydrate) and mica (potassium aluminium silicate)

Typically the acrylic copolymer basis (a) includes acrylic monomers and monomers of mono- and/or di-halogenated C₂-C₁₂-olefins, for example acrylic monomer combined with vinyl chloride and vinylidene chloride.

Compared with conventional anti-corrosive coating formulations based on a ylnyl/acrylic binder and a corrosion inhibiting pigment as an anti-corrosive ingredient, the amount of the anti-corrosive pigment in the inventive primer is substantially smaller in general. As mentioned above a conventional anti-corrosive acrylic coating typically includes 17 to 25 parts by weight of a corrosion inhibiting pigment as compared with 2 to 12 parts by weight in the inventive primer, both based on 100 parts by weight of the binder and calculated as dry matter.

Bearing in mind that the use of a conventional anti-corrosive acrylic coating as a primer followed by coating with a bituminous material cannot fulfil the requirements of corrosion inhibition, it is quite surprising that a corresponding primer having a lower content of an anti-corrosive pigment fulfils this requirement of a cathodic disbanding of maximum 10 mm (European Standard EN 10300:2005; 4,2,4,1 Table 3).

The extent of applicability of the invention appears from the following detailed description. It should, however, be understood that the detailed description and the specific examples are merely included to illustrate the preferred embodiments, and that various alterations and modifications within the scope of protection will be obvious to persons skilled in the art on the basis of the detailed description.

### DETAILED DESCRIPTION OF THE INVENTION

The binder of the inventive primer is a conventional acrylic binder for anti-corrosion coatings. The binder may be a copolymer of vinylidene chloride and/or vinyl chloride with one or more alkyl acrylates having from 1 to 12 carbon atoms in the alkyl group and/or one or more alkyl methacrylates having from 2 to 12 carbon atoms in the alkyl group and/or one or more aliphatic alpha-beta-unsaturated carboxylic acids and/or halogenated olefins of 2-12 carbon atoms.

An example of a suitable binder is the waterborne airdrying vinyl/acrylic copolymer designed for protection of steel available under the trade mark Haloflex® from DSM NeoResins, Waalwijk The Netherlands. Haloflex® is based on vinyl chloride and vinylidene chloride as the principal hard and soft monomers and is modified with acrylics.

Anti-corrosive coating compositions based on such binder includes a suitable amount of pigments. Such pigments may include anti-corrosive pigments, such as phosphates, and extenders. As mentioned above the recommended amount of an anti-corrosive pigment according to the prior art primer or coating compositions for steel protection is 17 to 25 parts by weight based on 100 parts by weight of the binder calculated as dry matter. The remaining amount of pigments is typically 42-100 parts by weight based on 100 parts by weight of the binder calculated as dry matter.

An important test for the anti-corrosive properties of a coating is the cathodic disbonding test (EN 10300:2005, Annex I) in which the disbanded radius in mm caused by an applied voltage in 28 days is determined. The requirements for steel tubes coated with a bitumen based enamel coating in conjunction with an appropriate primer by this cathodic disbonding test is maximum 10 mm (EN 10300:2005, 4.2.4.1, table 3).

As appears from the following example an anti-corrosive coating composition containing 21.5 parts by weight of aluminium triphosphate based on 100 parts by weight of the Haloflex®—calculated as dry matter—does not meet this requirement as the cathodic disbanding was 15 mm.

By some preliminary tests it was found that a reduction of the corrosion inhibitor from the conventional 17 to 25 parts by weight based on 100 parts by weight of the binder down to about 11 parts by weight did not—as expected—worsen the cathodic disbanding. Surprisingly the cathodic disbanding was reduced. After further test 4-7 parts by weight, for example about 5 parts by weight of aluminium triphosphate based on 100 parts by weight of the binder calculated as dry matter are at the present time believed to give the most satisfactory corrosion inhibiting results.

Based on the above findings the primer used by the present invention differs from the prior art anti-corrosive coating compositions by a lower amount of the anti-corrosive pigment, which for example may be 2 to 12 parts by weight based on 100 parts by weight of the Haloflex® binder calculated as dry matter. Preferably the total amount of pigments should not be changed. Accordingly, the remaining amount of pigments will typically be 40-85 parts by weight based on 100 parts by weight of the binder calculated as dry matter. As shown in the example a primer with 5 parts by weight based on 100 parts by weight of the binder gives a cathodic disbanding value of 8 mm meeting the maximum 10 mm requirement.

A preferred anti-corrosive pigment for use in the primer in connection with a bituminous coating is aluminium triphosphate such as K-White 84 available from Tayca Corporation, Osaka, Japan. Also other corrosion inhibiting pigments such as barium phosphate zinc phosphate, phosphosilicates and ion exchanged pigments are contemplated.

Further to the corrosion inhibiting pigments the primer composition contains other pigments suitable for use in anti-corrosive compositions including colouring pigments and extenders. Preferably a major amount of these “non-corrosioninhibiting” pigments are lamellar pigments because lamellar pigments provide a primer with improved adhesive and cohesive strengths, and also assist in reducing the rate of water diffusion through the coating. Examples of useful lamellar pigments are talc, (magnesium silicate hydrate) and mica (potassium aluminium silicate).

Typically also a minor amount of other pigments will be included for example for colouring purposes. A suitable example is carbon black.

Apart from the binder and pigments the primer may also contain one or more optional conventional additives and/or adjuvants known in the art. Examples thereof include—but are not limited to coalescents, thickeners, defoamers, stabilisers, wetting agents, preservatives, dispersing agents, flash rust inhibitors and pH regulators. The total amount of such additives and/or adjuvants is typically between 1 and 30% by weight based on the binder calculated as dry matter, preferably 8-25% by weight.

An important feature of the primer composition is that the ratio (b):(a) by weight of the corrosion inhibiting pigment (b) to the binder (a) is 2:100-12:100. Preferably the ratio (b):(a) is 3.4:100-8.5:100, even more preferred 4:100-7:100.

As stated above at least a major part of the “non-corrosion-inhibiting” or other pigments (c) should be lamellar pigments, such as talc. Thus at least 50% by weight, preferably at least 75% by weight and more preferred at least 85% by weight of the “non-corrosion-inhibiting” pigments should be lamellar pigments.

Due to the excellent bonding properties the inventive primer is suitable together with any conventional bituminous materials of the type used for external coating of steel tubes and fittings for onshore and offshore pipelines. Such materials—also termed bitumen based coating enamels—can be oxidized, non-oxidized or modified bitumen enamels. Such enamels may or may not contain a filler and they are normally applied in hot state.

### EXAMPLE

A waterborne primer according to the invention (Primer 1) with about 5 parts by weight of aluminium triphosphate per 100 parts by weight of vinyl chloride/vinylidene chloride/acrylic copolymer and two comparative primers (Primers A and B) with about 21.5 parts by weight of aluminium triphosphate per 100 parts by weight of vinyl chloride/vinylidene chloride/acrylic copolymer were prepared and applied on clean steel plates in accordance with European Standard EN 10300:2005, Annexes A and B. The compositions of the tested primers are shown in table 1.

TABLE 1

| | Primer 1 | | |
|---|---|---|---|
| | (according to | | |
| Ingredients (% w/w) | the invention) | Primer A | Primer B |
| Vinyl/acrylic binder | 47.41 | 45.32 | 47.38 |
| (Haloflex ® 202S) | | | |
| Aluminium triphosphate | 1.41 | 5.74 | 6.00 |
| (K-White 84) | | | |
| Talc (Westmin D30E) | 24.55 | 23.47 | 20.00 |
| Bentone LT | 0.20 | 0.19 | 0.20 |
| Anti foaming agent | 0.26 | 0.24 | 0.26 |
| (Foamaster ® H2) | | | |
| 20% Synperonic ® F87 | 1.04 | 0.99 | 1.04 |
| Wetting agent BYK 181 | 0.21 | 0.20 | 0.21 |
| Pigment paste Black CRE2 | 1.76 | 1.69 | 1.76 |
| Dipropylene glycol | 0.98 | 0.94 | 0.98 |
| monomethyl ether | | | |
| (Dowanol ® DPM) | | | |
| Butyl glycol | 0.98 | 0.94 | 0.98 |
| Emadox ® NA | 0.28 | 0.27 | 0.28 |
| Water | 20.92 | 20.01 | 20.91 |
| | 100 | 100 | 100 |
| K-White 84/Haloflex | 5.04 | 21.47 | 21.46 |
| 202S, (w/w, dry | | | |
| matter) × 100 | | | |

Haloflex®202S is available from DSM NeoResins, Waalwijk The Netherlands; the non volatile content of Haloflex®202S is about 59% w/w.
K-White 84 (aluminium triphosphate) is available from Tayca Corporation, Osaka, Japan.
Westmin D30E is available from Mondo Minerals OY, Helsinki, Finland
Bentone® LT is a suspending agent (thickener) of hectorite and hydroxyethylcellulose, available from Elementis Specialties, Inc. Hightstown, N.J., USA.
Foamaster® H2, anti foaming agent available from Cognis, Dusseldorf, Germany.
Synperonic® F87 is a nonionic stabilisator available from Uniqema, Gouda, The Netherlands
Byk 181 is an alkylolammonium salt of a polyfunctional anionic/nonionic polymer available from Byk Chemie, Wessel, Germany.
Dowanol® DPM is available from Dow Chemical Company. Midland, Mich., USA.
Emadox® NA is a flash rust inhibitor from Laboratoires Labema, Lorette, France.

A category 2 bitumen enamel coating (EN 10300:2005; 5.3.2.3) was then applied to the primed steel plates in accordance with (EN10300:2005, Annex C). The primed and coated plates were tested according to EN 10300:2005 to estimate sag (Annex D), impact (Annex E), peel (Annex F), bend (Annex G) and catodic disbonding (Annex I). The results are shown in Table 2.

TABLE 2

| | | Primer 1 | | |
|---|---|---|---|---|
| | | (according to | | |
| | | the invention) | Primer A | Primer B |
| Peel, mm | 30° C. | 0.0 | 0.0 | 0.0 |
| | 40° C. | 0.5 | 0.5 | 0.5 |
| | 50° C. | 0.0 | 0.0 | 0.0 |
| | 60° C. | 0.0 | 0.0 | 0.0 |

| | | | |
|---|---|---|---|
| Impact, 25° C., mm² | 4100 | 4200 | 4000 |
| Sag, 75° C., mm | 0.5 | 0.5 | 0.5 |
| Bend, 0° C., mm | >15 | >15 | >15 |
| Cathodic disbonding, mm | 8 | 15 | 17 |

The test results show that the inventive primer (primer 1) meets the requirements for the corrosion inhibiting effect as the cathodic disbanding is below the maximum value of 10 mm according to EN 10300:2005, 4.2.4.1, table 3. The comparative primers A and B do not meet this requirement although they both have a larger amount of the corrosion inhibiting aluminium triphosphate.

The above description of the invention reveals that it is obvious that it can be varied in many ways. Such variations are not to be considered a deviation from the scope of the invention, and all such modifications which are obvious to persons skilled in the art are also to be considered comprised by the scope of the succeeding claims.

1. A method for protecting iron or steel materials against corrosion by priming with a water borne primer composition comprising,
a) a binder of one or more acrylic copolymers based on one or more acrylic monomers and one or more chlorinated monomers,
b) a corrosion inhibiting pigment,
c) one or more further pigments,
d) optionally conventional additives and/or adjuvants, and
e) water.
and coating with a bituminous material.

2. A method according to claim 1, wherein a content of the corrosion inhibiting pigment (b) is 2-12 parts by weight based on 100 parts by weight of the binder (a) calculated as dry matter.

3. A method according to claim 1, wherein said further pigments (c) include lamellar pigments.

4. A method according to claim 1, wherein the corrosion inhibiting pigment (b) comprises a phosphate pigment.

5. A method according to claim 4, wherein the corrosion inhibiting phosphate pigment (b) comprises aluminium triphosphate.

6. A method according to claim 3, wherein the lamellar pigments (c) include talc and/or mica.

7. A method according to claim 1, wherein the acrylic copolymer basis (a) includes acrylic monomers and monomers of mono- and/or di-halogenated C₂-C₁₂-olefins.

8. A primer in an aqueous composition comprising,
a) a binder of one or more acrylic copolymers based on one or more acrylic monomers and one or more chlorinated monomers,
b) a corrosion inhibiting pigment,
c) one or more further pigments,
d) optionally conventional additives and/or adjuvants, and
e) water.

9. A primer according to claim 8, wherein a content of the corrosion inhibiting pigment (b) is 2-12 parts by weight based on 100 parts by weight of the binder (a) calculated as dry matter.

10. A primer according to claim 8, wherein said further pigments (c) include lamellar pigments.

11. A primer according to claim 8, wherein the corrosion inhibiting pigment (b) comprises a phosphate pigment.

12. A primer according to claim 11, wherein the corrosion inhibiting phosphate pigment (b) comprises aluminium triphosphate.

13. A primer according to claim 10, wherein the lamellar pigments (c) include talc and/or mica.

14. A primer according to claim, wherein the acrylic copolymer basis (a) includes acrylic monomers and monomers of mono- and/or di-halogenated C₂-C₁₂-olefins.

15. A method of using a primer for protecting materials against corrosion comprising:
priming with the primer comprising,
a) a binder of one or more acrylic copolymers based on one or more acrylic monomers and one or more chlorinated monomers,
b) a corrosion inhibiting pigment,
c) one or more further pigments,
d) optionally conventional additives and/or adjuvants, and
e) water; and
coating with a bituminous material.

16. The method according to claim 15 wherein the materials to be protected are onshore or offshore materials including pipelines.
